(19) United States
(12) Patent Application Publication
(10) Pub. No.: US 2015/0070129 A1
(43) Pub. Date: Mar. 12, 2015

(54) METHODS AND SYSTEMS FOR PROVIDING NAVIGATION ASSISTANCE TO A USER

(71) Applicant: Toyota Motor Engineering & Manufacturing North America, Inc., Erlanger, KY (US)

(72) Inventors: Douglas A. Moore, Livermore, CA (US); Joseph M.A. Djugash, San Jose, CA (US); Emrah A. Sisbot, Mountain View, CA (US)

(73) Assignee: Toyota Motor Engineering & Manufacturing North America, Inc., Erlanger, KY (US)

(21) Appl. No.: 14/025,240

(22) Filed: Sep. 12, 2013

(51) Int. Cl. G09B 21/00

(52) U.S. Cl. CPC G09B 21/003
USPC 340/4.12

(57) ABSTRACT

Methods and systems for providing navigation assistance to a user are disclosed. A method for providing navigation assistance to a user includes defining at least one virtual wall along at least a portion of a path for navigation through an environment. The at least one virtual wall is offset from the path by an offset distance. The method further includes determining a location of the user and providing tactile feedback to the user, automatically by a processor, when the location of the user is within a threshold distance of the at least one virtual wall.

### TECHNICAL FIELD

The present specification generally relates to methods and systems for providing navigation assistance to a user and, more specifically, methods and systems for providing navigation assistance to a user based on tactile feedback or audible feedback indicative of a virtual wall.

### BACKGROUND

Blind and visually impaired individuals often use physical structures, such as walls, as navigation aids. However, in an open space (a space in which a user cannot touch any surrounding structures with his or her person or tools), where these structures are not present (e.g., a field), navigation may become very difficult using traditional methods. Thus, it is desirable to provide navigation assistance to users in such open spaces in which physical navigation aids may not exist.

Accordingly, a need exists for alternative methods and systems for providing navigation assistance to a blind or visually impaired user.

### SUMMARY

In one embodiment, a method for providing navigation assistance to a user includes defining at least one virtual wall along at least a portion of a path for navigation through an environment. The at least one virtual wall is offset from the path by an offset distance. The method further includes determining a location of the user and providing tactile feedback to the user, automatically by a processor, when the location of the user is within a threshold distance of the at least one virtual wall.

In another embodiment, a system for providing navigation assistance to a user includes an electronic control unit. The electronic control unit includes a non-transitory electronic memory that stores a set of machine readable instructions and a processor for executing the machine readable instructions. The system further includes a tactile feedback device communicatively coupled with the electronic control unit. When executed by the processor, the machine readable instructions cause the system to define at least one virtual wall along at least a portion of a path for navigation through an environment. The at least one virtual wall is offset from the path by an offset distance. When executed by the processor, the machine readable instructions further cause the system to determine a location of the user and provide tactile feedback to the user with the tactile feedback device when the location of the user is within a threshold distance of the at least one virtual wall.

In yet another embodiment, a method for providing navigation assistance to a user includes defining at least one virtual wall along at least a portion of a path for navigation through an environment. The at least one virtual wall is offset from the path by an offset distance. The method further includes determining a location of the user and providing audible feedback to the user, automatically by a processor, when the location of the user is within a threshold distance of the at least one virtual wall.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an embodiment of a feedback guidance system for providing navigation assistance to a user, according to one or more embodiments shown and described herein;

FIG. 2 schematically depicts another embodiment of a feedback guidance system for providing navigation assistance to a user, according to one or more embodiments shown and described herein;

FIG. 3 depicts a schematic illustration of the feedback guidance system implemented in an open environment, according to one or more embodiments shown and described herein;

FIG. 4A depicts a schematic illustration of tactile feedback devices incorporated into a belt worn by a user, according to one or more embodiments shown and described herein; and

FIG. 4B depicts a schematic illustration of tactile feedback devices incorporated into wrist bands worn by a user, according to one or more embodiments shown and described herein.

### DETAILED DESCRIPTION

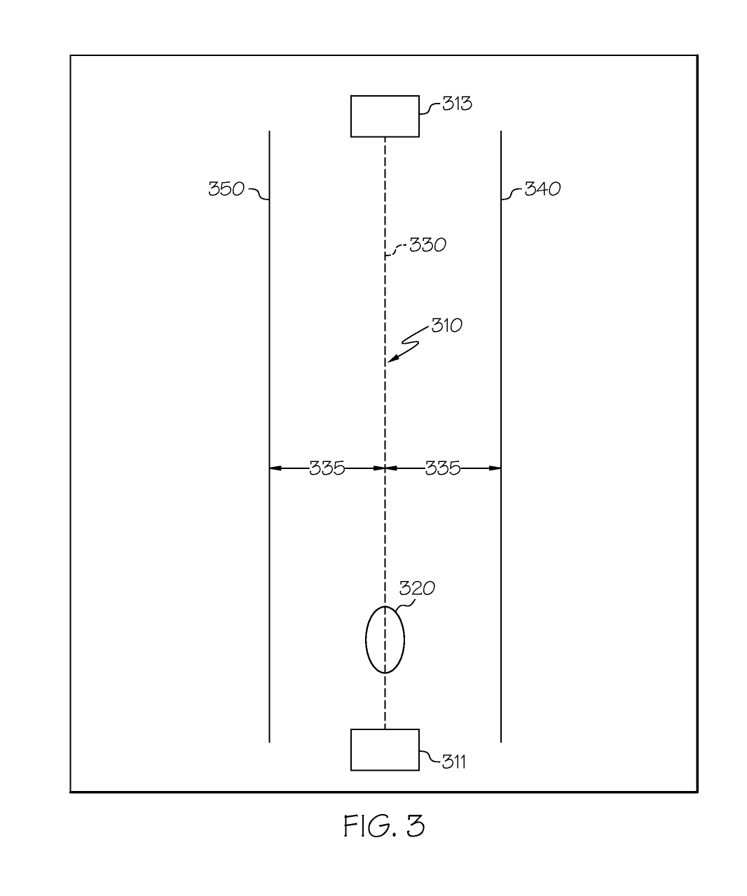

The embodiments disclosed herein generally include feedback guidance methods and systems for providing navigation assistance to visually impaired users through tactile feedback or audible feedback. Referring generally to FIG. 3, a virtual wall may be defined along at least a portion of a path through an environment and may be offset from the path by an offset distance. A location of the user may be determined. Tactile or audible feedback may be provided to the user when the location of the user is within a threshold distance of the virtual wall. Providing such tactile or audible feedback to a visually impaired user may provide navigation assistance to the user in a manner that the user is familiar with, thereby allowing the user to traverse an open space with ease. For example, a virtual wall may be defined along a portion of a path that traverses an open environment to provide non-visual feedback that allows the user to maintain the course along the planned path. Various embodiments of methods and systems for providing navigation system to a user will be described in more detail herein.

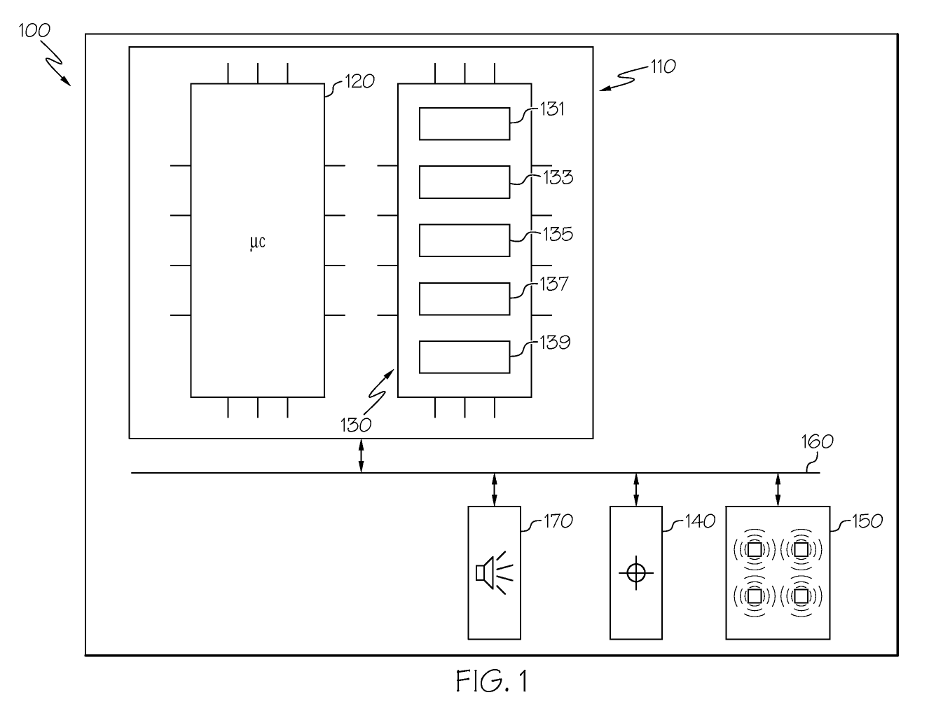

Referring now to the drawings, FIG. 1 schematically depicts an exemplary embodiment of a feedback guidance system 100 for providing navigation assistance to a user. The feedback guidance system 100 includes an electronic control unit 110 (including a processor 120 and a non-transitory electronic memory 130), a location sensor 140, a tactile feedback device 150, a communication path 160, and optionally, an audible feedback device 170. The various components of the feedback guidance system 100 will now be described.

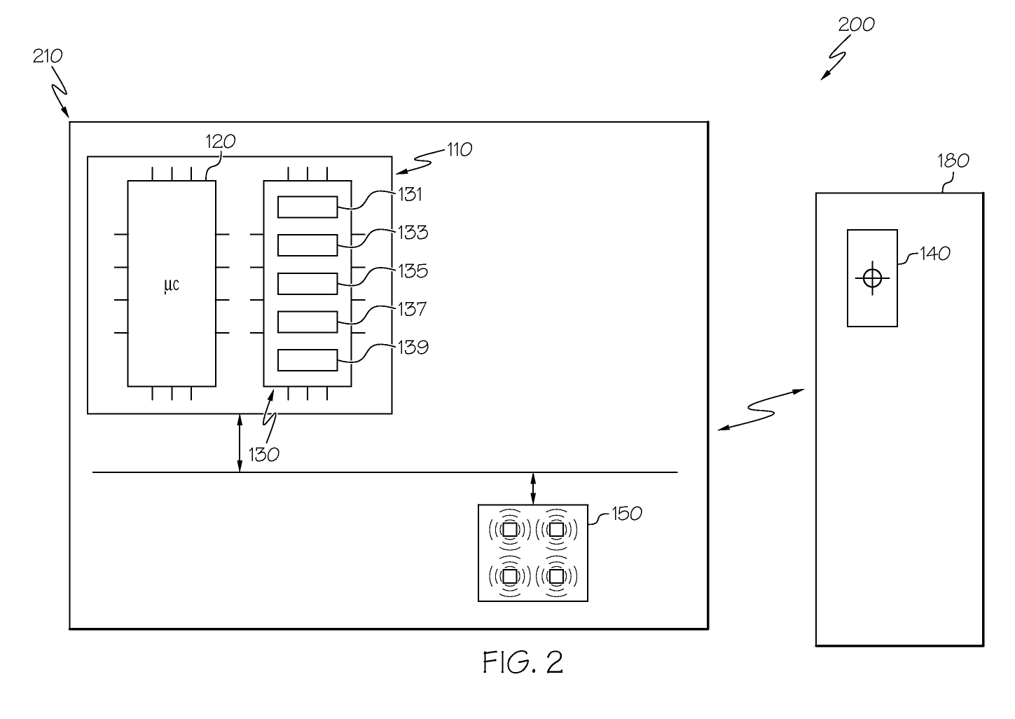

The feedback guidance system 100 comprises an electronic control unit 110 to which various components are communicatively coupled, as will be described in further detail below. In some embodiments, the electronic control unit 110 and/or the other components are included within a single device. In other embodiments, the electronic control unit 110 and/or the other components may be distributed among multiple devices that are communicatively coupled, an example of which is shown in FIG. 2, which will be described in further detail below.

The electronic control unit 110 includes a non-transitory electronic memory 130 that stores a set of machine readable instructions and a processor 120 for executing the machine readable instructions. The non-transitory electronic memory 130 may comprise RAM, ROM, flash memories, hard drives, or any device capable of storing machine readable instructions such that the machine readable instructions can be accessed by the processor 120. The machine readable instructions comprise logic or algorithm(s) written in any programming language of any generation (e.g., 1GL, 2GL, 3GL, 4GL, or 5GL) such as, for example, machine language that may be directly executed by the processor 120, or assembly language, object-oriented programming (OOP), scripting languages, microcode, etc., that may be compiled or assembled into machine readable instructions and stored in the non-transitory electronic memory 130. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The non-transitory electronic memory 130 may be implemented as one memory module or a plurality of memory modules.

In some embodiments, the non-transitory electronic memory 130 implements one or more logic operations to execute the functions of the feedback guidance system 100. These operations may include path planning logic 131, virtual wall generation logic 133, location determination logic 135, feedback determination logic 137, and operating logic 139. The path planning logic 131 may be configured to plan a path based on information in the non-transitory electronic memory 130 (e.g., information pertaining to the surrounding environment compiled from user inputs, electronic communication with other devices, or information gathered by the electronic control unit 110). The virtual wall generation logic 133 may be configured to define at least one virtual wall that is offset from the path, which may be utilized to assist a user with navigation, as will be described in further detail below. The location determination logic 135 may be configured to determine a user's location from information gathered by one or more location sensors or from information stored in the non-transitory electronic memory 130 (e.g., when the user's location is input with a user input device and stored in the non-transitory electronic memory 130). The feedback determination logic 137 may be configured to determine when and how to provide tactile feedback and/or audible feedback to the user. The feedback determination logic 137 will signal the tactile feedback device 150 and optionally the audible feedback device 170 to send feedback to the user. The operating logic 139 may include an operating system and/or other software for managing components of the feedback guidance system 100. The functionality of each of these logic modules will be described in further detail below.

The processor 120 may be any device capable of executing machine readable instructions. For example, the processor 120 may be an integrated circuit, a microchip, a computer, or any other computing device. The non-transitory electronic memory 130 and the processor 120 are coupled to a communication path 160 that provides signal interconnectivity between various components and/or modules of the feedback guidance system 100. Accordingly, the communication path 160 may communicatively couple any number of processors with one another, and allow the modules coupled to the communication path 160 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 160 may be formed from any medium that is capable of transmitting a signal such as, for example, conductive wires, conductive traces, optical waveguides, or the like. Moreover, the communication path 160 may be formed from a combination of mediums capable of transmitting signals. In some embodiments, the communication path 160 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

In the embodiments described herein, the non-transitory electronic memory 130 and the processor 120 are integral with the electronic control unit 110. However, it is noted that the electronic control unit 110, the non-transitory electronic memory 130, and the processor 120 may be discrete components communicatively coupled to one another without departing from the scope of the present disclosure.

As schematically depicted in FIG. 1, the communication path 160 communicatively couples the electronic control unit 110 with a plurality of other components of the feedback guidance system 100. For example, the feedback guidance system 100 depicted in FIG. 1 includes an electronic control unit 110 communicatively coupled with a location sensor 140, a tactile feedback device 150, and optionally, an audible feedback device 170.

The location sensor 140 may be any device capable of generating an output indicative of a location. In some embodiments, the location sensor 140 includes a global positioning system (GPS) sensor, a camera, a radio frequency identification (RFID) sensor, a time of flight (TOF) sensor, a laser, or an ultrasonic sensor. It should be understood that the location sensor 140 is not limited to the specific sensors identified above because the location sensor 140 includes any sensor capable of generating an output indicative of a location.

The tactile feedback device 150 may be any device capable of providing tactile feedback to a user. The tactile feedback device 150 may include a vibration device (such as in embodiments in which tactile feedback is delivered through vibration), an air blowing device (such as in embodiments in which tactile feedback is delivered through a puff of air), or a pressure generating device (such as in embodiments in which the tactile feedback is delivered through generated pressure). In some embodiments, the tactile feedback device 150 comprises an array of feedback devices that provide the user with more detailed feedback. For example, an array (e.g., a 2×2 array or 3×3 array) of tactile feedback devices can provide directional feedback to the user by only providing feedback on one side of the array, e.g., tactile feedback received on a left side of a user directs the user to move right. In some embodiments, the tactile feedback device 150 is wearable on the user, for example as a belt, a wristband, a waist-pack, an adhesive, or a button. In some embodiments, the tactile feedback device 150 is located in a device separate from some or all of the other components of the feedback guidance system 100 and communicatively coupled with the feedback guidance system 100.

The audible feedback device 170 may be any device capable of providing audible feedback to a user. The audible feedback device 170 may include a speaker, headphones, or the like. In some embodiments, the audible feedback may be delivered to the user with the speaker or headphones in a 3-dimensional (3D) audio placement format. In some embodiments, the audible feedback device 170 is integral with the feedback guidance system 100, as depicted in FIG. 1. In other embodiments, the audible feedback device 170 is wearable on the user, for example as a belt, a wristband, a pair of headphones, or a button. In further embodiments, the audible feedback device 170 is located in a device separate from some or all of the other components of the feedback guidance system 100 and communicatively coupled with the feedback guidance system 100. In some embodiments, the audible feedback device 170 is not included in the feedback guidance system 100.

While FIG. 1 depicts an electronic control unit 110, a location sensor 140, a tactile feedback device 150, and an optional audible feedback device 170 in a single, integral feedback guidance system 100, it should be understood that one or more of these components may be distributed among multiple devices in a variety of configurations.

For example, referring now to FIG. 2, another embodiment of an exemplary feedback guidance system 200 is schematically depicted. The feedback guidance system 200 depicted in FIG. 2 includes a feedback generation system 210 and a portable device 180. The feedback generation system 210 is communicatively coupled to the portable device 180, such as via a wired or wireless connection. As schematically depicted in FIG. 2, the location sensor 140 is included within the portable device 180. The portable device 180 transmits the sensed location to the feedback generation system 210. The electronic control unit 110 of the feedback generation system 210 may use the received location to provide tactile feedback and/or audible feedback via the tactile feedback device 150 and/or the audible feedback device in the same manner as described with respect to FIG. 1. Thus, it should be understood that any combination of components may be housed separately or together in a plurality of devices.

Referring now to the operation of the feedback guidance system 100 depicted in FIG. 1, a method for providing navigation assistance to a user includes defining a virtual wall along a path for navigation through an environment, determining the location of a user, and providing tactile feedback or audible feedback to the user when the location of the user is within a threshold distance of the virtual wall, as will now be described in further detail.

The machine readable instructions of the virtual wall generation logic 133, when executed by the processor 120, cause the feedback guidance system 100 to define at least one virtual wall along a path for navigation. In some embodiments, the feedback guidance system 100 defines the path for navigation by a user with the path planning logic 131. The path planning logic 131 may plan the path in a number of ways, such as using a path planning algorithm to plan the path from a current location or starting location to a destination location. The path planning logic 131 may include a path planning algorithm that plans the path using optimization methods, for example a “shortest distance” path planning optimization method or an “avoiding crowded locations” path planning algorithm.

Referring once again to the virtual wall generation logic 133, in some embodiments, the machine readable instructions of the virtual wall generation logic 133, when executed by the processor 120, cause the feedback guidance system 100 to define a single virtual wall that is offset from the path by an offset distance. For example, a virtual wall offset to the right of the path is configured to provide feedback to the user when the user comes within a threshold distance from virtual wall, i.e. the user strays too far to the right of the path and is alerted to correct course. In some embodiments, the threshold distance is zero. In some embodiments, the threshold distance is greater than zero. In some embodiments, the feedback guidance system 100 defines a first virtual wall and a second virtual wall, each offset from a centerline of the path. In embodiments that include a first virtual wall and a second virtual wall, the first virtual wall and the second virtual wall are each offset the same distance from the centerline of the path, creating a virtual corridor for the user to traverse. For example, the feedback guidance system can define virtual walls offset along each side of a path from a starting point to a destination point creating a virtual corridor along the entire path. Such virtual walls provide the user with the navigation benefits of physical walls as well as additional navigational benefits not provided by physical walls, as will be described in further detail below.

Still referring to the operation of the feedback guidance system 100, the machine readable instructions of the location determination logic 135, when executed by the processor 120, cause the feedback guidance system 100 to determine the location of the user. The location determination logic 135 determines the location of the user based on the output of the location sensor 140. The location determined by the location determination logic 135 allows the feedback guidance system 100 to locate the user and compare the user's location to the location of the virtual wall. In some embodiments, the location sensor comprises a GPS sensor that determines the location of the user and provides the determined location to the feedback guidance system 100 for processing with the location determination logic 135. As noted above, in some embodiments, the location sensor 140 includes a camera operable to sense the location and movement of a user. A camera, or other embodiments of the location sensor, can locate the user as a whole or can locate more specific segments of a user, such as a user's hand or a cane.

As also noted above, the location sensor 140 may include a time of flight (TOF) camera which uses a range imaging system to resolve distance and location by measuring the TOF of a light signal between the camera and the user. In some embodiments, the location sensor determines the location of a user with a laser. In this embodiment, a laser is reflected off the user and user location is determined by analyzing the reflected light. In other embodiments, the location sensor comprises ultrasonic location sensing technology. In some embodiments, sensing and locating the user is accomplished using traditional techniques for localization (when the map of the environment is known) such as Extended Kalman filter, Particle filters or any other such filtering mechanism.

Still referring to the operation of the feedback guidance system 100, the machine readable instructions of the feedback determination logic 137, when executed by the processor 120, cause the feedback guidance system 100 to provide tactile feedback or audible feedback to the user. When the feedback guidance system 100 determines that the user is a threshold distance from a defined virtual wall, the feedback determination logic 137 transmits a signal to the tactile feedback device 150 and/or the audible feedback device 170 to provide feedback to a user. In some embodiments, the tactile feedback is provided as vibrations, air puffs, pressure, or the like. In other embodiments, the audible feedback is provided as speech or abstract sounds. In further embodiments, feedback is provided in multiple forms, each associated with a particular function or location. For example, the feedback guidance system 100 may be configured to recognize a discrete location and transmit unique feedback related to that location. For example, a coffee shop may be associated with a unique audible or tactile feedback such that that particular feedback is provided to the user each time the user is near that coffee shop. Such unique feedback can be implemented for multiple locations, providing the user information about their surroundings without visual cues.

As noted above, in some embodiments, the tactile feedback device 150 comprises an array of tactile feedback devices, such as vibrating devices. In embodiments that include an array of tactile feedback devices, the feedback determination logic 137 may provide the user more detailed information about his or her location with respect to the virtual wall and the surrounding environment. For example, a tactile feedback device 150 that includes an array of vibrators may be incorporated into a wearable device, such as a belt. The feedback determination logic 137 may signal feedback using the array to provide feedback depending on the location of the user with respect to the virtual wall or the surrounding environment. For example, when the user contacts (or comes within a threshold distance of) a virtual wall on his or her left side, the feedback determination logic may activate the vibrators on the left side of the tactile feedback array. Such feedback may inform the user that the user has contacted (or has come within a threshold distance of) a virtual wall on his or her left. More complex arrays may be provided in order to communicate more precise feedback to the user. It should be understood that the tactile feedback device 150 may be housed in a plurality of devices, both wearable and non-wearable.

In some embodiments, the optional audible feedback device 170 provides audible feedback to mimic natural sounds of the physical world. Visually impaired individuals often use echolocation to navigate. In some embodiments, the audible feedback device 170 provides audible feedback indicative of the virtual wall in a manner that mimics the sound that may be reflected from a physical wall for the purposes of echolocation. For example, an individual may tap a cane on the ground and determine his or her distance to a physical wall by the sound of the reverberation. In a similar manner, some embodiments of the feedback guidance system 100 use the audible feedback device 170 to provide audible feedback to a user mimicking the sound of a cane tap reverberated off a physical wall in response to the feedback guidance system 100 sensing a tap of a cane. Such audible feedback may allow a user to determine his or her distance from a virtual wall.

In some embodiments, the feedback determination logic 137 signals the tactile feedback device 150 and/or the audible feedback device 170 to provide feedback when the distance between the user and a virtual wall reaches a threshold distance. In some embodiments, the feedback is binary such that there is either no feedback or feedback at a consistent intensity. In some embodiments, the feedback is provided in a gradient format such that the intensity of the feedback varies based on the location of the user with respect to the virtual wall, the environment or other conditions. In some embodiments, for example, as the user approaches the threshold distance between the user and the virtual wall, feedback is provided with increasing intensity until the threshold distance is reached. Once the threshold distance is reached, full feedback intensity is provided. Gradient feedback may be incorporated into audible feedback and/or tactile feedback. In some embodiments, as the user approaches the threshold distance, audible feedback is provided by the audible feedback device at an increasing volume until the threshold distance is reached and full feedback volume is provided. In some embodiments, as the user approaches a threshold distance, tactile feedback is provided by the tactile feedback device at an increasing intensity, for example, increasing vibrations, until the threshold distance is reached and full intensity tactile feedback is provided.

In some embodiments, the feedback guidance system 100 may be toggled into alternative modes, for example a normal operating mode, a minimal feedback mode, and a learning mode. The normal operating mode may function as described above. In the minimal feedback mode, the tactile feedback and/or audible feedback provided to the user may be reduced and certain components, such as the virtual wall, may be disabled. In the learning mode, the user, often under the guidance of a friend, may follow a path that the feedback guidance system 100 “learns” by storing information indicative of the path in the non-transitory electronic memory 130. Once the path information is stored, the feedback guidance system 100 may use this information to plan the path along which the virtual wall is defined. In the learning mode, the feedback guidance system 100 may continue to sense the user's location within the environment and stores the location information in the non-transitory electronic memory 130 for future use. Upon future reference of this learned path, the feedback guidance system 100 is able to provide navigation assistance to the user as the user traverses the learned path by defining at least one virtual wall along the path and providing the user the various forms of feedback available in the feedback guidance system 100. In some embodiments, learning mode may operate simultaneous with other modes, for example, the feedback guidance system can learn new information about paths and the surrounding environment while in minimal feedback mode or in normal operating mode.

In some embodiments, the feedback guidance system 100 determines the location of hazards along the path and in the surrounding environment. When the user approaches a hazard, feedback is provided to the user to alert them of potential danger. Hazard feedback can be provided through the tactile feedback device 150 and/or the audible feedback device 170. In some embodiments, hazard feedback may be provided to the user when the virtual walls are enabled.

Referring now to FIG. 3, an illustration of the feedback guidance system 100 implemented in an environment is schematically depicted and will now be described. FIG. 3 schematically depicts a path 310 that traverses through an environment from a starting point 311 to a destination point 313. In some embodiments, the environment is open, such that there are few physical walls or structure. The feedback guidance system defines a first virtual wall 340 and a second virtual wall 350 along the path 310 in the environment to assist a user 320 in navigating the path 310. The first virtual wall 340 and the second virtual wall 350 are each offset from the path 310 an offset distance 335. In the embodiment depicted in FIG. 3, the path 310 further comprises a centerline 330 that extends along the path 310. In the embodiment depicted in FIG. 3, the first virtual wall 340 and the second virtual wall 350 are offset the same offset distances 335 from the centerline 330. However, it should be understood that in some embodiments, the first virtual wall 340 and the second virtual wall 350 are offset different distances from the centerline 330. In some embodiments, only a single virtual wall is defined by the feedback guidance system 100.

Referring still to FIG. 3, a user 320 is depicted on the path 310 near a starting point 311. In some embodiments, the user 320 wishes to traverse the path 310 from the starting point 311 to the destination point 313. As the user 320 traverses the path 310, the feedback guidance system 100 will provide tactile feedback and/or audible feedback to the user 320 through one of the multiple configurations of the feedback guidance system 100 discussed above when the user 320 reaches a threshold distance from the first virtual wall 340 or the second virtual wall 350. In one example implementation of the feedback guidance system 100, if a user 320 starts traversing the path 310 near the starting point 311 and drifts within the threshold distance of the first virtual wall 340, the feedback guidance system 100 will provide tactile feedback and/or audible feedback indicative of the first virtual wall 340, thereby informing the user 320 that he or she should move towards the middle of the path 310. If the user 320 then drifts within the threshold distance the second virtual wall 350, the feedback guidance system 100 will provide tactile feedback and/or audible feedback indicative of the second virtual wall 350, thereby informing the user 320 that he or she should move towards the middle of the path 310. This interaction between the user 320 and the virtual walls will continue as the user 320 traverses the path 310 from the starting point 311 to the destination point 313. This provides the user 320 with feedback to inform the user 320 when he or she should move back towards the middle of the path 310.

As shown in FIG. 3, utilizing the feedback guidance system 100 in the environment depicted in FIG. 3, allows a user 320 to traverse a path 310 through an open environment without the assistance of visual guidance tools.

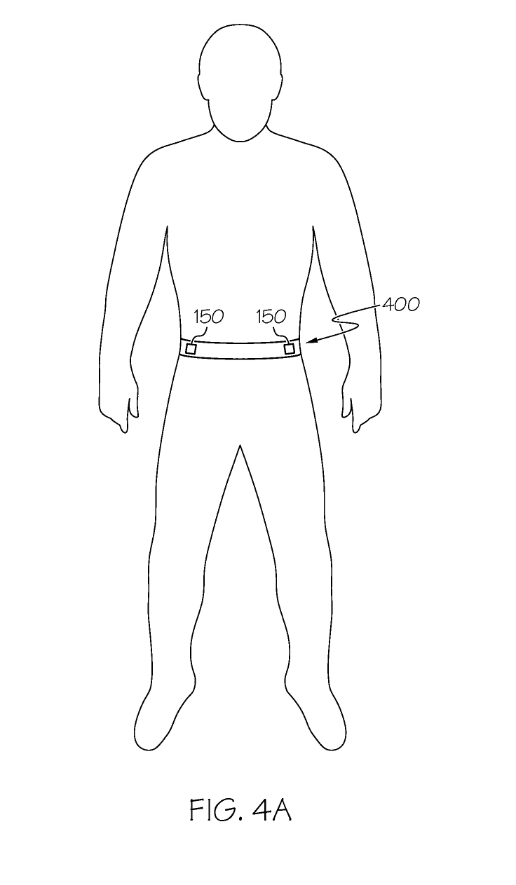

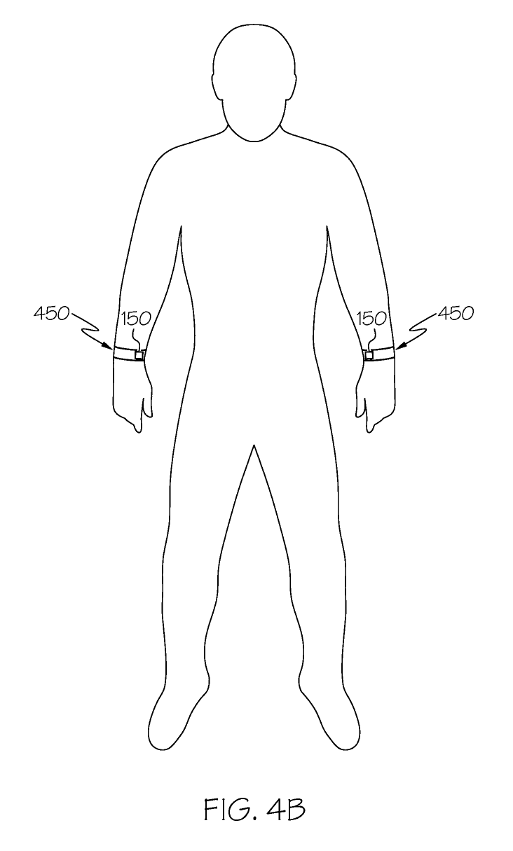

FIGS. 4A and 4B illustrate two non-limiting examples of wearable devices that may provide feedback to a user. Referring now to FIG. 4A, an illustration of two tactile feedback devices 150 incorporated into a belt 400 is schematically depicted and will now be described. It should be understood that the two tactile feedback devices 150 are shown as an example not a limitation. In some embodiments, one tactile feedback device 150 may be incorporated into the belt 400. In other embodiments, three or more tactile feedback devices 150 may be incorporated into the belt 400. FIG. 4A schematically depicts a user wearing a belt 400 with tactile feedback devices 150 incorporated into the belt 400. The tactile feedback devices 150 may be attached to the belt 400, integrated within the belt 400, or incorporated into the belt 400 through any other manner of attachment. In some embodiments, the tactile feedback devices 150 are disposed on opposite sides of the belt 400, as depicted in FIG. 4A. In this embodiment, the tactile feedback devices 150 could provide selective tactile feedback to the user, e.g. only providing tactile feedback through the tactile feedback device 150 located on the left side of the user to inform the user that he or she reached a threshold distance from a virtual wall on his or her left side and that the user should move back towards the middle of a path. A plurality of tactile feedback devices 150 can be incorporated into the belt 400 to provide the user with more specific tactile feedback. Although FIG. 4A illustrates tactile feedback devices 150 incorporated into a belt 400, it should be understood that the feedback guidance system 100 can be incorporated in part or in whole into a wearable device such as the belt 400 of FIG. 4A.

Referring now to FIG. 4B, a tactile feedback device 150 incorporated into a wrist band 450 is schematically depicted. FIG. 4B schematically depicts a user wearing a pair of wrist bands 450, each with a tactile feedback device 150 incorporated into the wrist bands 450. In some embodiments, one tactile feedback device 150 may be incorporated into each wrist band 450 or both wrist bands 450. In other embodiments, two or more feedback devices 150 may be incorporated into each wrist band 450 or both wrist bands 450. The tactile feedback device 150 may be attached to the wrist band 450, integrated within the wrist band 450, or incorporated into the wrist band 450 through any other manner of attachment. In this embodiment, the tactile feedback device 150 could provide selective tactile feedback to the user, e.g. only providing tactile feedback through the tactile feedback device 150 of the wrist band 450 located on the user's right wrist to inform the user that they reached a threshold distance from a virtual wall on the user's right side and that the user should move back towards the middle of a path. A plurality of tactile feedback devices 150 can be incorporated into one or more wrist bands 450 to provide the user with more specific tactile feedback. Although FIG. 4B illustrates tactile feedback devices 150 incorporated into wrist bands 450, it should be understood that the feedback guidance system 100 can be incorporated in part or in whole into any wearable device such as the wrist bands 450 of FIG. 4B.

It should now be understood that the embodiments described herein relate to feedback guidance systems for providing tactile and audible navigation assistance to a visually impaired user, in a manner they are familiar with in an open environment. The embodiments provide a flexible and adaptive feedback guidance system that defines virtual walls, provides a user with the navigation benefits of a physical wall and is tailored to provide straightforward and precise navigation assistance. The embodiments provide a user with tactile or audible feedback to provide intuitive navigation assistance and allow a visually impaired user to traverse open environments with ease.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing navigation assistance to a user, the method comprising:
defining at least one virtual wall along at least a portion of a path for navigation through an environment, wherein the at least one virtual wall is offset from the path by an offset distance;
determining a location of the user; and
providing tactile feedback to the user, automatically by a processor, when the location of the user is within a threshold distance of the at least one virtual wall.

2. The method of claim 1, wherein the threshold distance is zero.

3. The method of claim 1, wherein:
the path includes a centerline;
the at least one virtual wall includes a first virtual wall and a second virtual wall; and
the first virtual wall and the second virtual wall are offset from the centerline.

4. The method of claim 1, wherein providing tactile feedback to the user includes providing vibration, providing an air puff, or providing pressure.

5. The method of claim 1, further comprising:
detecting a hazard along the path; and
providing tactile feedback when the hazard is detected.

6. The method of claim 1, wherein the location of the user is determined based on a location of a hand of the user or a location of a cane.

7. The method of claim 1, wherein tactile feedback is provided to the user through an array of vibrating devices, air blowing devices, or pressure generating devices.

8. A system for providing navigation assistance to a user, the system comprising:
an electronic control unit comprising a non-transitory electronic memory that stores a set of machine readable instructions and a processor for executing the machine readable instructions; and
a tactile feedback device communicatively coupled with the electronic control unit, wherein when executed by the processor, the machine readable instructions cause the system to:
define at least one virtual wall along at least a portion of a path for navigation through an environment, wherein the at least one virtual wall is offset from the path by an offset distance;
determine a location of the user; and
provide tactile feedback to the user with the tactile feedback device when the location of the user is within a threshold distance of the at least one virtual wall.

9. The system of claim 8, wherein the threshold distance is zero.

10. The system of claim 8, wherein the path includes a centerline, the at least one virtual wall includes a first virtual wall and a second virtual wall, and the first virtual wall and the second virtual wall are offset from the centerline.

11. The system of claim 8, wherein providing tactile feedback to the user includes providing vibration, providing an air puff, or providing pressure.

12. The system of claim 8, wherein when executed by the processor, the machine readable instructions cause the system to:
detect a hazard along the path; and
provide tactile feedback when the hazard is detected.

13. The system of claim 8, wherein the location of the user is determined based on a location of a hand of the user or a location of a cane.

14. The system of claim 8, wherein the system is integrated into a wearable device.

15. The system of claim 8, further comprising an audible feedback device communicatively coupled with the electronic control unit, wherein when executed by the processor, the machine readable instructions cause the system to:
provide audible feedback to the user with the audible feedback device when the location of the user is within the threshold distance of the at least one virtual wall.

16. A method for providing navigation assistance to a user, the method comprising:
defining at least one virtual wall along at least a portion of a path for navigation through an environment, wherein the at least one virtual wall is offset from the path by an offset distance;
determining a location of the user; and
providing audible feedback to the user, automatically by a processor, when the location of the user is within a threshold distance of the at least one virtual wall.

17. The method of claim 16, wherein the threshold distance is zero.

18. The method of claim 16, wherein:
the path includes a centerline;
the at least one virtual wall includes a first virtual wall and a second virtual wall; and
the first virtual wall and the second virtual wall are offset from the centerline.

19. The method of claim 16, further comprising:
detecting a hazard along the path; and
providing audible feedback when the hazard is detected.

20. The method of claim 16, further comprising:
determining a distance of the user from the virtual wall; and
providing audible feedback to the user, wherein the audible feedback is indicative of the distance of the user from the virtual wall.
